(19) United States
(12) Patent Application Publication
(10) Pub. No.: US 2007/0254132 A1
(43) Pub. Date: Nov. 1, 2007

(54) Adhesive Sheet Having Resilience Properties

(75) Inventors: Hermann Neuhaus-Steinmetz, Ahrensburg (DE); Frank Henke, Neu Wulmstorf (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, HAMBURG (DE)

(21) Appl. No.: 10/583,752

(22) PCT Filed: Nov. 24, 2004
(86) PCT No.: PCT/EP04/53082

§ 371 Date: Mar. 15, 2007

(30) Foreign Application Priority Data
Dec. 22, 2003 (DE) 103 61 164.9

(51) Int. Cl. B32B 5/00

(52) U.S. Cl. 428/98

(57) ABSTRACT

Adhesive sheet, particularly for use in a punching operation, composed at least of a backing and a layer of an adhesive, characterized in that the backing is in a mechanically stressed state.

This application is a 371 of PCT/EP2004/053082, filed Nov. 24, 2004, which claims foreign priority benefit under 35 U.S.C. § 119 of the German Patent Application No. 103 61 164.9 filed Dec. 22, 2003.

The invention relates to an adhesive sheet having resilience properties and also to punched products produced using an adhesive sheet of this kind.

Front plates with writing on and functional plates for electronic and other devices are adhered in large quantities industrially to housings or other substrates using double-sided adhesive tapes. Punches are used to bring the adhesive tape, starting from roll or bale material, into the desired shape. At the punched-through edges, however, the adhesives tend to coalesce again, since there are no forces present for retraction from the punched edges. This is so even more if the punched, shaped areas are removed not immediately but only at a later point in time, which is the case particularly for manual further processing.

In the case of prior-art, double-sided adhesive tapes used customarily the partial recoalescence of adhesives at punched and cut edges in automatic processing leads to lower machine speeds and increased rejection. In manual processing the partial recoalescence of adhesives leads to considerable extra processing work.

DE 100 52 955 A1 discloses the use of pressure-sensitive adhesives having anisotropy properties for punched products. The anisotropy properties give such pressure-sensitive adhesives a resilience if they are coated in the drawn state onto a backing.

Publications DE 101 57 152 A1 and 101 57 153 A1 describe processes for producing punched pressure-sensitive adhesive products by means of pressure-sensitive adhesives of this kind. There, adhesives are applied to a backing using coating dies, in the drawn state. The elastic recession forces of the adhesives result in their retraction from punched and cut edges during processing, whereby reducing the coalescence with the consequence of unwanted resticking.

Owing to the viscoelasticity properties that are needed for an adhesive tape, with the ability to flow out on substrates, the stressed state brought about by applying the adhesive in the drawn state subsides within a few weeks. Consequently, an adhesive tape produced in this way must be processed a short time after production, so that the desired effect can come about. Particularly in the case of transport and storage in hot regions, this time is further curtailed, so that in such regions the work required for the processing of such adhesive tapes is almost impossible to accomplish.

Furthermore, in the course of production, the adhesive is drawn only in the running direction of the machine, so that the desired effect is observable only in the case of punched or cut edges transverse to the running direction. In the case of punched or cut edges in the longitudinal direction exactly the same tendency towards resticking is present as with conventional adhesive tapes.

It is an object of the invention to provide adhesive sheets which as compared with the state of the art have improved processing properties, especially in punching or diecutting operations, for which, in particular during or after a punching or cutting operation, the punched or cut edges do not stick to one another again, and which exhibit the advantageous properties for a sufficiently long period of time.

This object is achieved by means of adhesive sheets as described herein.

The present invention accordingly relates in one embodiment to an adhesive sheet, particularly for use in a punching operation, which is composed at least of a backing and a layer of an adhesive, the backing being present in a mechanically stressed state.

The term “films” should be understood as referring comprehensively to sheetlike structures of all kinds and hence embraces two-dimensionally sheetlike structures (e.g. roll product, bale product) and also elongate structures (e.g. adhesive tapes). Likewise embraced are structures whose two-dimensional extent is limited (e.g. labels).

As a result of the mechanically stressed state, adhesive sheets of this kind possess a resilience, so that in the punching, cutting or squeezing operation there is retraction of the backing and hence of the adhesive sheet itself. Recoalescence of the adhesive can therefore be prevented.

The resilience can be brought about by the adhesive sheet being held mechanically in the stressed state, for instance by the adhesive sheet further comprising a release liner (anti-stick sheet, release film) whose mechanical stiffness is greater than that of the backing material. As a result of the mechanical properties of the backing and those of the release liner it is possible for the stresses to be retained over a long time.

Alternatively to this, or else additionally, the mechanically stressed state can also be frozen in, particularly such that the film has a resilience as a result of supply of energy. One advantageous embodiment of the adhesive sheet is distinguished by the fact that a shrink film is used as backing material.

Shrink films are cold-drawn thermoplastic polymer films which on heat treatment contract back to their original state (“memory”, “elastic shape memory”). Alternatively to the cold drawing, the drawing operation can also be carried out under hot conditions and the drawn film then cooled.

Where shrink films are used as backings the forces required for retraction of the backing with the adhesive can be built up directly during punching or cutting by supplying energy, such as by heating, for example.

Advantageous adhesive sheets of the invention are double-sidedly adhering; that is, in the case of these sheets, the backing is coated with adhesive on both sides.

In one advantageous embodiment a release liner is coated with an adhesive. The backing is heated, and so stretches in the longitudinal and transverse direction with respect to the web, and is then laminated in the hot state onto the cold adhesive, with the release liner on the other side, and so, in the course of cooling, a mechanical stress is built up between the release liner and the backing. So that the backing remains stretched and does not crumple the release liner, the mechanical stiffness of the release liner should be greater than that of the backing. In a further operation a second layer of adhesive is placed onto the remaining bare face of the backing. In the course of production and further processing there should always be a sufficient web tension and the windings forming bales or rolls should always be made such that the backing is at the bottom in relation to the release liner; otherwise there may easily be cross-folding, with detachment of the release liner from the first adhesive.

In a further advantageous embodiment a release liner is coated with an adhesive. A backing having elasticity properties is stretched in the longitudinal and transverse direction with respect to the running of the web, and in this state the stretched backing is laminated onto the adhesive, with the release liner on the other side, so producing a mechanical stress between the release liner and the backing.

In a further advantageous embodiment a release liner is coated with an adhesive, a backing having sufficient elasticity properties is stretched by means of the web tension in the longitudinal direction with respect to the running of the web, and in this state the stretched backing is laminated onto the adhesive, with the release liner on the other side, thereby building up a mechanical stress between the release liner and the backing. In this case, however, the backing with the adhesives does not retract at punched or cut edges in the running direction of the web in the course of further processing, but only at punched or cut edges transverse to the running direction of the web. An advantageous feature of this version are the simple and cost-effective manufacturing possibilities.

In a further advantageous embodiment a release liner is coated with an adhesive and the backing used is a shrink film which is laminated onto the adhesive, with the release liner on the other side. In the course of further processing in punching or cutting operations the adhesive tape is heated directly before the operation, during the operation or directly thereafter, as a result of which the shrink film of the adhesives retracts from the edges. Alternatively the shrink film can be subjected to heating during the actual production of the adhesive tape, after lamination, so that in this case the conditions which arise are the same as those in the aforementioned backing stretched in the longitudinal and transverse directions.

Improved resilience in the adhesive sheet can be obtained by virtue of at least one adhesive possessing an elastic resilience. In the case of double-sided adhesive sheets, advantageously, both adhesives exhibit this resilience.

As adhesive with inherent resilience use is made advantageously of anisotropic adhesives.

Particularly suitable for this purpose are pressure-sensitive adhesives based on at least 65% by weight of at least one acrylic monomer from the group of compounds of the general formula CH₂═(CR¹)COOR², where R¹═H or CH₃ and R² is selected to be H, CH₃ or a group from the group from the branched or unbranched, saturated alkyl groups having 2 to 20 carbon atoms, and for which, moreover, the average molecular weight M_{w} is at least 650 000 g/mol. When applied to a backing the pressure-sensitive adhesive possesses a preferential direction such that the refractive index measured in the preferential direction, n_{MD}, is greater than the refractive index measured in a direction perpendicular to the preferential direction, n_{CD}, with the difference Δn=n_{MD}−n_{CD} being at least 1×10⁻⁵.

Also suitable are pressure-sensitive adhesive systems which comprise at least one pressure-sensitive adhesive based on at least one block copolymer, the weight fractions of the block copolymers in total accounting for at least 50% of the pressure-sensitive adhesive, at least one block copolymer being composed at least partially on the basis of (meth)acrylic derivatives, and additionally at least one block copolymer comprising at least the unit P(A)-P(B)-P(A) comprising at least one polymer block P(B) and at least two polymer blocks P(A), and where

P(A) independently of one another represent homopolymer or copolymer blocks of monomers A, the polymer blocks P(A) each having a softening temperature in the range from +20° C. to +175° C.,

P(B) represents a homopolymer or copolymer block comprising monomers B, the polymer block P(B) having a softening temperature in the range from −130° C. to +10° C.,

the polymer blocks P(A) and P(B) are not homogeneously miscible with one another, and

the pressure-sensitive adhesive system is oriented, in that it possesses a preferential direction, with the refractive index measured in the preferential direction, n_{MD}, being greater than the refractive index measured in a direction perpendicular to the preferential direction, n_{CD}.

The invention further provides punched products produced by punching an adhesive sheet as described above.

What is claimed is:

1. Adhesive sheet comprising at least a backing and a layer of an adhesive, wherein the backing is in a mechanically stressed state.

2. Adhesive sheet according to claim 1, wherein the adhesive sheet further comprises a release liner whose mechanical stiffness is greater than that of the backing material.

3. Adhesive sheet according to claim 1, wherein the mechanically stressed state is frozen in that the film has a resilience as a result of supply of energy.

4. Adhesive sheet according to claim 1, wherein a shrink film is used as backing material.

5. Adhesive sheet according to claim 1, wherein the backing is coated on both sides with adhesive.

6. Adhesive sheet according to claim 1, wherein at least one adhesive has an elastic resilience.

7. A process for producing punched products comprising punching the products from an adhesive sheet according to claim 1.

8. Punched products produced according to the process according to claim 7.
